(19) United States
(12) Patent Application Publication
(10) Pub. No.: US 2019/0112322 A1
(43) Pub. Date: Apr. 18, 2019

(54) CARBINOL FUNCTIONAL TRISILOXANE AND METHOD OF FORMING THE SAME

(71) Applicants: Dow Silicones Corporation, Midland, MI (US); Dow Corning Toray Co., Ltd., Tokyo (JP)

(72) Inventors: Eric J. JOFFRE, Midland, MI (US); Lenin J. PETROFF, Bay City, MI (US); Tsunehito SUGIURA, Chiba (JP); Seiki TAMURA, Chiba (JP); Zachary R. WENZLICK, Freeland, MI (US)

(21) Appl. No.: 16/096,977

(22) PCT Filed: Apr. 26, 2017
(86) PCT No.: PCT/US2017/029598

§ 371 Date: Oct. 26, 2018

Related U.S. Application Data
(60) Provisional application No. 62/328,082, filed on Apr. 27, 2016.

(51) Int. Cl. C07F 7/08

(52) U.S. Cl. CPC C07F 7/0838; C07F 7/0879

(57) ABSTRACT

A trisiloxane having at least one carbinol functional group comprises the reaction product of (A) an initial trisiloxane and (B) an organic compound. Component (A) has a pendant silicon-bonded functional group selected from a hydrogen atom, an epoxy-containing group, an ethylenically unsaturated group, and an amine group. Typically, component (A) is free of certain terminal silicon-bonded functional groups and is free of polyoxyalkylene groups. Component (B) has a functional group reactive with the pendant silicon-bonded functional group of component (A), and has at least one hydroxyl functional group. The trisiloxane is useful for a number of applications including use as a detergent additive. The trisiloxane may be of the following general formula (I): (R13SiO1/2) (R1R3Si2/2)(R13SiO1/2) (I). In formula (I), each R1 is an independently selected hydrocarbyl group. R3 may be selected from the groups (i) to (iv) described herein. Typically, the trisiloxane has 1-6 carbinol groups.

The present invention generally relates to a trisiloxane, and more specifically to a trisiloxane having at least one carbinol functional group and to a method of forming the trisiloxane. The trisiloxane is typically free of polyoxyalkylene groups, e.g. the trisiloxane is PEG-free, and is useful for a number of applications including, but not limited to, use as a detergent additive.

Trisiloxane polyether materials are known to be effective surfactants. They can reduce the surface energy of aqueous solutions to around 20 dynes/cm at low concentrations. This has allowed them to be utilized in a range of applications such as agricultural adjuvants, inks and coatings.

Unfortunately, the chemical makeup of trisiloxane polyether materials has presented a number of issues. For example, the use of trisiloxane polyether materials in many detergent applications has been limited because most commercial trisiloxane polyether materials are either soluble or easily dispersible in water. This classifies the trisiloxane polyether materials as “surfactants” per the European Union (EU) detergent directive (i.e., Regulation (EC) No. 648/2004 of the European Parliament and of the Council on detergents). Thus, the trisiloxane polyether materials must be readily biodegradable by methods defined in the EU detergent directive. Based on the common methodology of biodegradation, trisiloxane polyether materials are not known to biodegrade sufficiently to satisfy the EU detergent directive. Hence, the use of trisiloxane polyether materials in these applications is limited.

In view of the foregoing, there remains an opportunity to provide improved trisiloxane materials. There also remains an opportunity to provide methods of making such trisiloxane materials.

### BRIEF SUMMARY OF THE INVENTION

A trisiloxane having at least one carbinol functional group is provided. The trisiloxane comprises the reaction product of (A) an initial trisiloxane and (B) an organic compound. Component (A) has a pendant silicon-bonded functional group. The pendant silicon-bonded functional group is generally selected from a hydrogen atom, an epoxy-containing group, an ethylenically unsaturated group, and an amine group. Typically, component (A) is free of a terminal silicon-bonded functional group selected from a hydrogen atom, an epoxy-containing group, an ethylenically unsaturated group, and an amine group. Component (A) is also typically free of polyoxyalkylene groups. Component (B) has a functional group reactive with the pendant silicon-bonded functional group of component (A). Component (B) also has at least one hydroxyl functional group.

The trisiloxane is subject to the following provisos. If the pendant silicon-bonded functional group of component (A) is a hydrogen atom, the functional group of component (B) is an ethylenically unsaturated group. If the pendant silicon-bonded functional group of component (A) is an epoxy-containing group, the functional group of component (B) is an amine group. If the pendant silicon-bonded functional group of component (A) is an ethylenically unsaturated group, the functional group of component (B) is a hydrogen atom. If the pendant silicon-bonded functional group of component (A) is an amine group, the functional group of component (B) is an epoxy-containing group.

In various embodiments, the trisiloxane is of the following general formula (I):

(R¹₃SiO_{1/2})(R¹R³SiO_{2/2})(R¹₃SiO_{1/2}) (I).

In formula (I) above, each R¹ is an independently selected hydrocarbyl group. R³ may be selected from the following groups (i) to (iv):

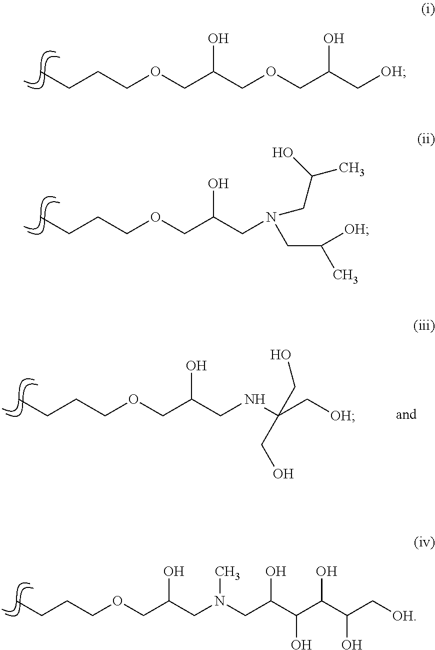 [SMILES: CCCCOCC(O)COCC(O)CO ; CCCCOCC(O)CN(CC(C)O)CC(C)O ; CCCCOCC(O)CNC(CO)(CO)CO ; CCCCOCC(O)CN(C)CC(O)C(O)C(O)C(O)CO]

A method of forming the trisiloxane is also provided. The method comprises the steps of 1) providing component (A) and 2) providing component (B). The method further comprises the step of 3) reacting components (A) and (B) to form the trisiloxane. The trisiloxane is useful for a number of applications including, but not limited to, use as a detergent additive.

### BRIEF DESCRIPTION OF THE DRAWINGS

FIG. 1 is a reaction scheme illustrating a method of forming a trisiloxane; and

FIG. 2 is a reaction scheme illustrating an alternate method of forming the trisiloxane.

### DETAILED DESCRIPTION

The term “ambient temperature” or “room temperature” refers to a temperature between about 20° C. and about 30° C. Usually, room temperature ranges from about 20° C. to about 25° C. All viscosity measurements referred to herein were measured at 25° C. unless otherwise indicated. The following abbreviations have these meanings herein: “Me” means methyl, “Et” means ethyl, “Pr” means propyl, “Bu” means butyl, “g” means grams, “ppm” means parts per million, “h” means hours, “GC/MS” means gas chromatography and mass spectrometry, and “NMR” means nuclear magnetic resonance.

“Hydrocarbyl” means a monovalent hydrocarbon group which may be substituted or unsubstituted. Specific examples of hydrocarbyl groups include alkyl groups, alkenyl groups, alkynyl groups, aryl groups, aralkyl groups, etc.

“Alkyl” means an acyclic, branched or unbranched, saturated monovalent hydrocarbon group. Alkyl is exemplified by, but not limited to, Me, Et, Pr (e.g. iso-Pr and/or n-Pr), Bu (e.g. iso-Bu, n-Bu, tert-Bu, and/or sec-Bu), pentyl (e.g. iso-pentyl, neo-pentyl, and/or tert-pentyl), hexyl, heptyl, octyl, nonyl, decyl, undecyl, and dodecyl as well as branched saturated monovalent hydrocarbon groups of 6-12 carbon atoms. Alkyl groups may have 1-30, alternatively 1-24, alternatively 1-20, alternatively 1-12, alternatively 1-10, and alternatively 1-6, carbon atoms.

“Alkenyl” means an acyclic, branched or unbranched, monovalent hydrocarbon group having one or more carbon-carbon double bonds. Alkenyl is exemplified by, but not limited to, vinyl, allyl, methallyl, propenyl, and hexenyl. Alkenyl groups may have 2-30, alternatively 2-24, alternatively 2-20, alternatively 2-12, alternatively 2-10, and alternatively 2-6, carbon atoms.

“Alkynyl” means an acyclic, branched or unbranched, monovalent hydrocarbon group having one or more carbon-carbon triple bonds. Alkynyl is exemplified by, but not limited to, ethynyl, propynyl, and butynyl. Alkynyl groups may have 2-30, alternatively 2-24, alternatively 2-20, alternatively 2-12, alternatively 2-10, and alternatively 2-6, carbon atoms.

“Aryl” means a cyclic, fully unsaturated, hydrocarbon group. Aryl is exemplified by, but not limited to, cyclopentadienyl, phenyl, anthracenyl, and naphthyl. Monocyclic aryl groups may have 5-9, alternatively 6-7, and alternatively 5-6, carbon atoms. Polycyclic aryl groups may have 10-17, alternatively 10-14, and alternatively 12-14, carbon atoms.

“Aralkyl” means an alkyl group having a pendant and/or terminal aryl group or an aryl group having a pendant alkyl group. Exemplary aralkyl groups include tolyl, xylyl, mesityl, benzyl, phenylethyl, phenyl propyl, and phenyl butyl.

“Alkenylene” means an acyclic, branched or unbranched, divalent hydrocarbon group having one or more carbon-carbon double bonds. “Alkylene” means an acyclic, branched or unbranched, saturated divalent hydrocarbon group. “Alkynylene” means an acyclic, branched or unbranched, divalent hydrocarbon group having one or more carbon-carbon triple bonds. “Arylene” means a cyclic, fully unsaturated, divalent hydrocarbon group.

“Carbocycle” and “carbocyclic” each mean a hydrocarbon ring. Carbocycles may be monocyclic or alternatively may be fused, bridged, or spiro polycyclic rings. Monocyclic carbocycles may have 3-9, alternatively 4-7, and alternatively 5-6, carbon atoms. Polycyclic carbocycles may have 7-17, alternatively 7-14, and alternatively 9-10, carbon atoms. Carbocycles may be saturated or partially unsaturated.

“Cycloalkyl” means a saturated carbocycle. Monocyclic cycloalkyl groups are exemplified by cyclobutyl, cyclopentyl, and cyclohexyl. “Cycloalkylene” means a divalent saturated carbocycle.

The term “substituted” as used in relation to another group, e.g. a hydrocarbyl group, means, unless indicated otherwise, one or more hydrogen atoms in the hydrocarbyl group has been replaced with another substituent. Examples of such substituents include, for example, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amines, amino-functional groups, amido-functional groups, and cyano-functional groups; sulphur atoms; and sulphur atom containing groups such as mercapto groups.

M, D, T, and Q units are generally represented as RᵤSiO_{(4-u)/2}, where u is 3, 2, 1, and 0 for M, D, T, and Q, respectively, and R is an independently selected hydrocarbyl group. The M, D, T, Q designate one (Mono), two (Di), three (Tri), or four (Quad) oxygen atoms covalently bonded to a silicon atom that is linked into the rest of the molecular structure.

### Trisiloxane

A trisiloxane having at least one carbinol functional group is provided. The term “carbinol” refers to a hydroxyl group bound to a carbon atom (C—OH) and is differentiated from a hydroxyl group bound to a silicon atom (Si—OH). The carbinol functional group is generally linked to the siloxane backbone by a non-hydrolyzable moiety. The trisiloxane may also be referred to as a carbinol-functional trisiloxane, as a hydroxy-functional trisiloxane, and in some instances, as a polyol-functional trisiloxane.

As understood in the silicone art, trisiloxanes generally include a D unit flanked on each said by an M unit, i.e., by terminal M units. Moreover, trisiloxanes are generally free of both T and Q units.

In various embodiments, the trisiloxane has one (1) to six (6), alternatively two (2) to five (5), and alternatively three (3) to four (4), carbinol functional groups. The carbinol functional group(s) of the trisiloxane may remain free and/or be subsequently utilized for reaction. For example, free carbinol functional groups may be useful for aqueous applications due to their hydrophilicity, whereas siloxane backbones are useful for their hydrophobicity. Alternatively, carbinol functional groups may be subsequently reacted into/with various materials, including polyurethanes, epoxies, polyesters, phenolics, etc. As understood in the art, carbinol functional groups may undergo the same conversion or reaction possibilities that are generally associated with hydroxyl groups.

The trisiloxane comprises the reaction product of (A) an initial trisiloxane and (B) an organic compound. The term “initial” means that component (A) is different from the trisiloxane of the present invention, which is formed via reaction of components (A) and (B). The term “organic” means that component (B) comprises carbon, alternatively comprises carbon and hydrogen. In many embodiments, component (B) is free of silicon.

In various embodiments, the reaction product consists essentially of components (A) and (B). As used herein, the phrase “consisting essentially of” generally encompasses the specifically recited elements/components for a particular embodiment. Further, the phrase “consisting essentially of” generally encompasses and allows for the presence of additional or optional elements/components that do not materially impact the basic and/or novel characteristics of that particular embodiment. In certain embodiments, “consisting essentially of” allows for the presence of ≤10, ≤5, or ≤1, weight percent (wt %) of additional or optional components based on the total weight of the reaction product. In other embodiments, the reaction product consists of components (A) and (B).

As used herein, the designations “(A)” and “(B)” are not to be construed as requiring a particular order or indicating a particular importance of one component relative to the other. Specifically, enumeration may be used in the description of various embodiments. Unless otherwise expressly stated, the use of enumeration should not be construed as limiting the present invention to any specific order or number of components. Nor should the use of enumeration be construed as excluding from the scope of the present invention any additional components or steps that might be combined with or into the enumerated components or steps.

### Component (A)

Component (A) has a pendant silicon-bonded functional group. The pendant silicon-bonded functional group is generally selected from a hydrogen atom, an epoxy-containing group, an ethylenically unsaturated group, and an amine group. The “pendant” silicon-bonded functional group is linked to the D unit of the trisiloxane.

In certain embodiments, the pendant silicon-bonded functional group is a hydrogen atom. In other embodiments, the pendant silicon-bonded functional group is an epoxy-containing group. The epoxy-containing group may be an epoxy group or an epoxy group linked to the silicone backbone by a non-hydrolyzable moiety. In other embodiments, the pendant silicon-bonded functional group is an ethylenically unsaturated group. Suitable ethylenically unsaturated groups for component (A) include alkenyl groups, e.g. vinyl, allyl, methallyl, propenyl, hexenyl, etc. In certain embodiments, component (A) has a pendant silicon-bonded alkenyl group, e.g. an allyl group. In yet other embodiments, the pendant silicon-bonded functional group is an amine group.

Typically, component (A) is free of a terminal silicon-bonded functional group selected from a hydrogen atom, an epoxy-containing group, an ethylenically unsaturated group, and an amine group. If they were present, such “terminal” silicon-bonded functional groups would be linked to at least one of the M units of the trisiloxane.

Typically, component (A) is free of polyoxyalkylene groups. If they were present, polyoxyalkylene groups may be imparted by, for example, the polymerization of ethylene oxide (EO), propylene oxide (PO), butylene oxide (BO), 1,2-epoxyhexane, 1,2-epoxyoctance, and/or cyclic epoxides, such as cyclohexene oxide or exo-2,3-epoxynorborane. Common polyoxyalkylene moieties in the art include oxyethylene units (C₂H₄O), oxypropylene units (C₃H₆O), oxybutylene units (C₄H₈O), or mixtures thereof. In certain embodiments, the trisiloxane may be referred to as being polyether-free, e.g. PEG-free, PEO-free, POE-free, PPG-free, PPOX-free, POP-free, PTMG-free, PTMEG-free, or PTHF-free. Such acronyms are understood in the art. In many embodiments, the trisiloxane is free of polyoxyalkylene groups.

In various embodiments, component (A) is of the following general formula (A1):

(R¹₃SiO_{1/2})(R¹R²SiO_{2/2})(R¹₃SiO_{1/2}) (A1).

In formula (A1) above, each R¹ is an independently selected hydrocarbyl group. In certain embodiments, each R¹ is an independently selected C₁-C₆ alkyl group. In specific embodiments, each R¹ is a methyl group. R² is the pendant silicon-bonded functional group.

In certain embodiments, R² is the hydrogen atom; so component (A) may be referred to as a hydrogentrisiloxane. In other embodiments, R² is the epoxy-containing group; so component (A) may be referred to as an epoxy-functional trisiloxane. In other embodiments, R² is the ethylenically unsaturated group; so component (A) may be referred to as an alkenyl-functional trisiloxane. In yet other embodiments, R² is the amine group; so component (A) may be referred to as an amine-functional trisiloxane.

### Component (B)

Component (B) has at least one hydroxyl (—OH) functional group. The hydroxyl functional group is generally inert with respect to component (A). By “generally inert,” it is meant that reaction of the hydroxyl functional group(s) is not intended. Specifically, while hydroxyl functional groups are reactive, e.g. with Si—H groups, reaction is minimized or generally avoided during formation of the trisiloxane such that a majority to all of the hydroxyl groups remain free. The hydroxyl functional group(s) of component (B) can be protected from side-reaction during formation of the trisiloxane by methods understood in the art, such as by controlling reaction conditions, order of addition, temporary blocking/capping, etc. The carbinol functional group(s) of the trisiloxane is/are typically linked to the D unit of the trisiloxane and is/are generally imparted by at least the hydroxyl functional group(s) of component (B), and optionally, an opened epoxy ring (the epoxy ring being present prior to reaction of components (A) and (B)). The hydroxyl functional group(s) may be terminal and/or pendant (with respect to the group/moiety pending from the D unit of the trisiloxane).

Component (B) also has a functional group reactive with the pendant silicon-bonded functional group of component (A). Specifically, the trisiloxane is subject to the following provisos. If the pendant silicon-bonded functional group of component (A) is the hydrogen atom, the functional group of component (B) is an ethylenically unsaturated group. If the pendant silicon-bonded functional group of component (A) is the epoxy-containing group, the functional group of component (B) is an amine group. If the pendant silicon-bonded functional group of component (A) is an ethylenically unsaturated group, the functional group of component (B) is a hydrogen atom. If the pendant silicon-bonded functional group of component (A) is an amine group, the functional group of component (B) is an epoxy-containing group. The functional group of component (B) may be terminal, internal or pendant. In various embodiments, the functional group of component (B) is terminal.

Suitable ethylenically unsaturated groups for component (B) include alkenyl groups, e.g. vinyl, allyl, methallyl, propenyl, hexenyl, etc. In various embodiments, component (B) has an alkenyl group, e.g. an allyl group. Specific examples of suitable allyl compounds as component (B) include allyl glycerol, allyl diglycerol, allyl glycidyl ether (AGE), allyl sorbitol, etc. Allyl glycerol may also be referred to as allyloxyethanol. Allyl glycerol may also be referred to as allyl monoglycerol or allyloxy 1,2-propanediol. Other useful compounds as component (B) include epoxides such as glycidol and 4-vinyl-1-cyclohexene 1,2-epoxide. Other compounds having at least one epoxy and/or at least one ethylenically unsaturated group, and generally 1-6 hydroxyl group(s), are also contemplated.

In other embodiments, component (B) may be an amine compound, e.g. a secondary amine, provided there is also at least one hydroxyl functional group. Other suitable amine compounds as component (B) include alkanol modified amines such as generally: HNRR′ where R and R′ are alkyl and/or alkanol functionalities. One of R or R′ typically contains a secondary hydroxyl functionality to provide the hydroxyl functional group(s). Specific examples of suitable alkanol amines as component (B) include diisopropanol amine (DIPA), diethanol amine (DEA), etc. Other compounds having at least one amine group and generally 1-6 hydroxyl group(s) are also contemplated.

In various embodiments, the pendant silicon-bonded functional group of component (A) is the hydrogen atom and component (B) is the following component (B1):

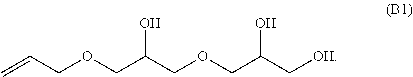

In other embodiments, the pendant silicon-bonded functional group of component (A) is an epoxy-containing group and component (B) is selected from the following components (B2) to (B4):

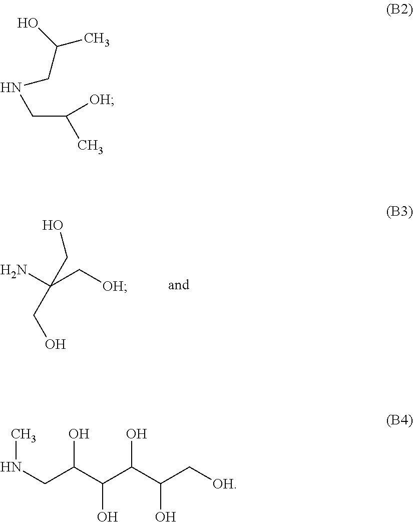

In yet other embodiments, the pendant silicon-bonded functional group of component (A) is the hydrogen atom and component (B) is selected from the following components (B5) to (B9):

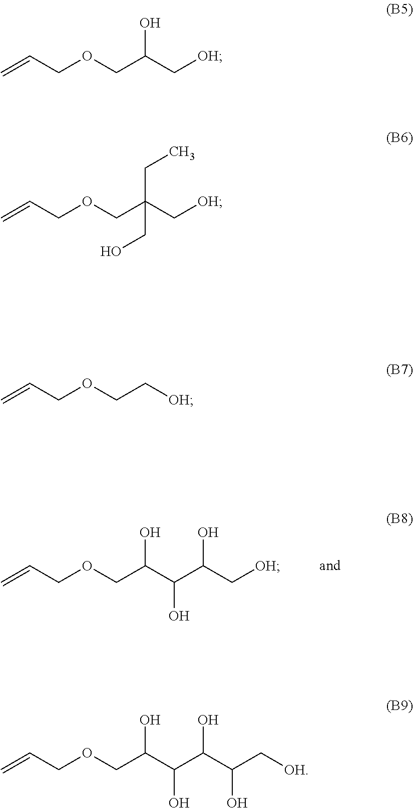

In further embodiments, the pendant silicon-bonded functional group of component (A) is the epoxy-containing group and component (B) is following component (B10):

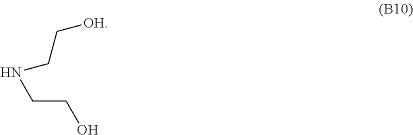

In certain embodiments, component (B) is component: (B1); (B2); (B3); (B4); (B5); (B6); (B7); (B8); (B9); or (B10). Combinations of components (A) and (B) may be utilized.

In other embodiments where the functional groups of components (A) and (B) are inversed, for example, where the pendant silicon-bonded functional group of component (A) is the amine group and the functional group of component (B) is the epoxy-containing group, component (B) is an epoxy compound, provided there is also at least one hydroxyl functional group. In these embodiments, component (B) may be an epoxy functional polyol. Such epoxy polyols may be selected from components similar to components (B2) to (B4) or (B10), but where the amine group is generally replaced with an epoxy-containing group, e.g. an epoxy group (not shown). While not explicitly illustrated above, it is to be appreciated that other compounds suitable as component (B) can also be utilized.

In yet other embodiments, component (B) has a hydrogen atom, provided there is also at least one hydroxyl functional group. In these embodiments, the hydrogen atom is a silicon-bonded hydrogen atom (Si—H), which is generally required in instances were component (A) includes the ethylenically unsaturated group. Such a Si—H functional group of component (B) may be imparted by first reacting an initial organic compound with a silane, a polysiloxane, etc. Such reactions are understood by those skilled in the silicone art.

### Trisiloxane

In various embodiments, the trisiloxane is of the following general formula (I):

(R¹₃SiO_{1/2})(R¹R³SiO_{2/2})(R¹₃SiO_{1/2}) (I).

In formula (I) above, each R¹ is as described above with formula (A1). R³ is typically an organic-based group having from 1-6 hydroxyl groups. In various embodiments, R³ is selected from the following groups (i) to (iv):

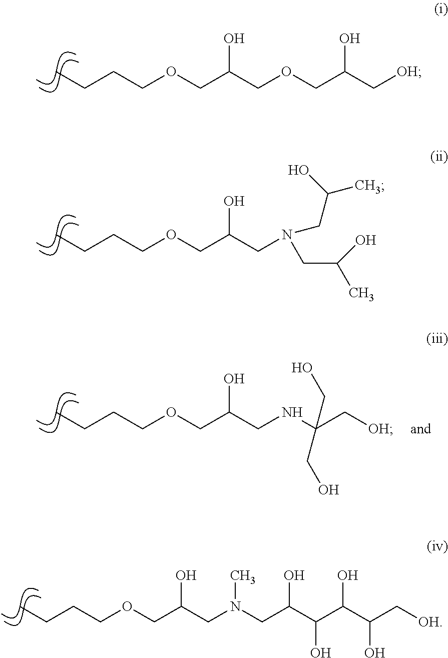 [SMILES: CCCCOCC(O)COCC(O)CO ; CCCCOCC(O)CN(CC(C)O)CC(C)O ; CCCCOCC(O)CNC(CO)(CO)CO ; "and" ; CCCCOCC(O)CN(C)CC(O)C(O)C(O)C(O)CO]

In other embodiments, R³ is selected from the following groups (v) to (x):

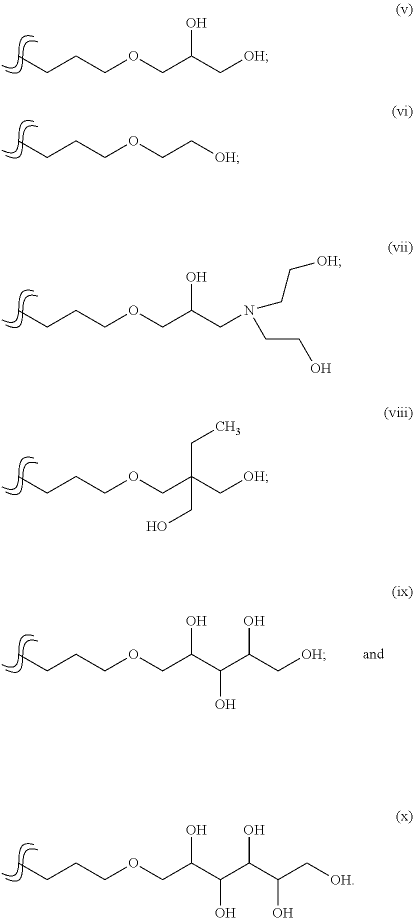

In certain embodiments, R³ in general formula (I) above is group: (i); (ii); (iii); or (iv). In other embodiments, R³ in general formula (I) above is group: (v); (vi); (vii); (viii); (ix); or (x).

In other embodiments where the functional groups of components (A) and (B) are inversed, for example, where the pendant silicon-bonded functional group of component (A) is the amine group and the functional group of component (B) is the epoxy-containing group, R³ may be selected from groups similar to groups ii) to iv) or vii), but where the moieties imparted by the amine and epoxy-containing groups are generally inversed/reversed (not shown). One of skill in the art will appreciate such inversed structures, related structures and other structures suitable for other embodiments of the trisiloxane.

### Method

A method of forming the trisiloxane is also provided. The method comprises the steps of 1) providing component (A) and 2) providing component (B). The method further comprises the step of 3) reacting components (A) and (B) to form the trisiloxane. Components (A) and (B) are as described above. Each of components (A) and (B) may be obtained or formed. For example, one or both of components (A) and (B) can be commercially obtained from a chemical supplier such as Dow Corning of Midland, Mich. Otherwise, one or both of components (A) and (B) can be formed from respective starting materials.

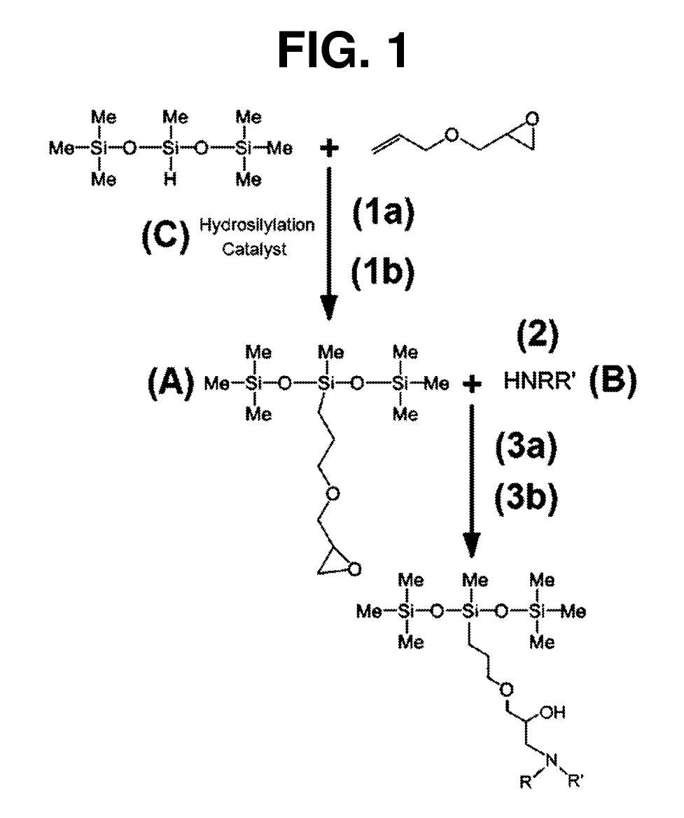

In a first general embodiment of the method, step 1) is further defined as 1a) reacting a hydrogentrisiloxane with an epoxy compound having an ethylenically unsaturated group in the presence of (C) a hydrosilylation catalyst to form a reaction intermediate having the epoxy-containing group. The reaction intermediate is component (A), specifically an epoxy-functional trisiloxane. In addition, step 3) is further defined as 3a) reacting component (B) and the reaction intermediate formed in step 1a) to form the trisiloxane. Component (B) is an amine compound. Optionally, the method further comprises the step(s) of 1b) removing unreacted epoxy compound after step 1a), and/or 3b) removing unreacted component (B) after step 3a). Such removal may be accomplished via methods understood in the art, e.g. via stripping, evaporating, pulling vacuum, etc. Other reactants, carrier fluids, and/or reaction-intermediates can similarly be removed as desired. An example of the first general embodiment of the method is illustrated in FIG. 1.

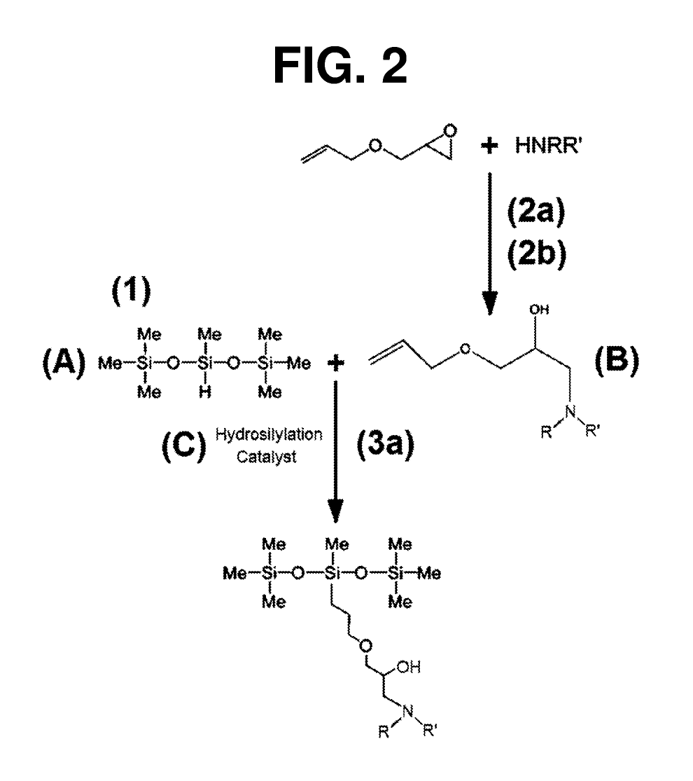

In a second general embodiment of the method, step 2) is further defined as 2a) reacting an amine compound having at least one hydroxyl functional group with an epoxy compound having an ethylenically unsaturated group to form a reaction intermediate having the ethylenically unsaturated group. The reaction intermediate is component (B). In addition, step 3) is further defined as 3a) reacting component (A) and the reaction intermediate formed in step 2a) in the presence of (C) a hydrosilylation catalyst to form the trisiloxane. Component (A) is a hydrogentrisiloxane (or silicone hydride). Optionally, the method further comprises the step(s) of 2b) removing unreacted compounds after step 2a), and/or 3b) removing unreacted component (A) after step 3a). Again, such removal may be accomplished via methods understood in the art. Other reactants, carrier fluids, and/or reaction-intermediates can similarly be removed as desired. An example of the second general embodiment of the method is illustrated in FIG. 2.

In a third general embodiment of the method (not shown), step 1) is further defined as 1a) reacting a hydrogentrisiloxane with an amine compound having an ethylenically unsaturated group in the presence of (C) a hydrosilylation catalyst to form a reaction intermediate having an amine group. The reaction intermediate is component (A), specifically an amine-functional trisiloxane. In addition, step 3) is further defined as 3a) reacting component (B) and the reaction intermediate formed in step 1a) to form the trisiloxane. Component (B) is an epoxy compound, such as glycidol. Optionally, the method further comprises the step(s) of 1b) removing unreacted amine compound after step 1a), and/or 3b) removing unreacted component (B) after step 3a). Such removal may be accomplished via methods understood in the art. Other reactants, carrier fluids, and/or reaction-intermediates can similarly be removed as desired. In related embodiments of the method, the amine-functional trisiloxane (A) can be made in alternate manners understood in the art. For example, a chloropropyl functional trisiloxane can be reacted with ammonia to form component (A). One skilled in the art can readily appreciate other manners in which to obtain amine-functional trisiloxanes suitable as component (A) for forming the trisiloxane.

In a fourth general embodiment of the method (not shown), step 2) is further defined as 2a) reacting an epoxy compound having at least one hydroxyl functional group with an amine compound having an ethylenically unsaturated group to form a reaction intermediate having the ethylenically unsaturated group. The reaction intermediate is component (B). In addition, step 3) is further defined as 3a) reacting component (A) and the reaction intermediate formed in step 2a) in the presence of (C) a hydrosilylation catalyst to form the trisiloxane. Component (A) is a hydrogentrisiloxane (or silicone hydride). Optionally, the method further comprises the step(s) of 2b) removing unreacted compounds after step 2a), and/or 3b) removing unreacted component (A) after step 3a). Again, such removal may be accomplished via methods understood in the art. Other reactants, carrier fluids, and/or reaction-intermediates can similarly be removed as desired.

Components (A) and (B) can be reacted in various amounts to form the trisiloxane. Based on the number of respective functional groups, the components can be utilized in a 1:1 stoichiometric ratio (A:B). Higher or lower ratios may also be utilized. For example, excess component (A) or (B) may be desired for certain end-uses/applications of the trisiloxane or composition including the trisiloxane. Reaction conditions are not particularly limited. In certain embodiments, reaction is performed at a temperature of from room temperature to a reflux temperature for 1-24, alternatively 1-10, hours.

### Component (C)

The hydrosilylation (or addition) reaction, e.g. between Si—H and ethylenically unsaturated groups, typically takes place in the presence of (C) a hydrosilylation catalyst. The hydrosilylation catalyst may be conventional to the art. For example, the hydrosilylation catalyst may be a platinum group metal-containing catalyst. By “platinum group” it is meant ruthenium, rhodium, palladium, osmium, iridium and platinum and complexes thereof. Non-limiting examples of hydrosilylation catalysts useful herein are described in U.S. Pat. Nos. 3,159,601; 3,220,972; 3,296,291; 3,419,593; 3,516,946; 3,715,334; 3,814,730; 3,923,705; 3,928,629; 3,989,668; 5,036,117; 5,175,325; and 6,605,734; each of which is incorporated herein by reference with respect to their disclosed hydrosilylation catalysts.

The hydrosilylation catalyst can be platinum metal, platinum metal deposited on a carrier, such as silica gel or powdered charcoal, or a compound or complex of a platinum group metal. Typical hydrosilylation catalysts include chloroplatinic acid, either in hexahydrate form or anhydrous form, and/or a platinum-containing catalyst which is obtained by a method comprising reacting chloroplatinic acid with an aliphatically unsaturated organosilicon compound, such as divinyltetramethyldisiloxane, or alkene-platinum-silyl complexes as described in U.S. Pat. No. 6,605,734. An example is: (COD)Pt(SiMeCl₂)₂ where “COD” is 1,5-cyclooctadiene. These alkene-platinum-silyl complexes may be prepared, e.g. by mixing 0.015 mole (COD)PtCl₂ with 0.045 mole COD and 0.0612 moles HMeSiCl₂.

One suitable platinum catalyst type is Karstedt's catalyst, which is described in Karstedt's U.S. Pat. Nos. 3,715,334 and 3,814,730. Karstedt's catalyst is a platinum divinyl tetramethyl disiloxane complex typically containing about 1 wt % of platinum in a solvent, such as toluene. Another suitable platinum catalyst type is a reaction product of chloroplatinic acid and an organosilicon compound containing terminal aliphatic unsaturation (described in U.S. Pat. No. 3,419,593).

The amount of hydrosilylation catalyst used is not particularly limited and typically depends upon the particular catalyst. The hydrosilylation catalyst is typically utilized in an amount sufficient to provide at least 2 ppm, more typically 4-200 ppm of platinum based on total weight percent solids (all non-solvent ingredients), based on one million parts of component (A) or (B). In various embodiments, the hydrosilylation catalyst is present in an amount sufficient to provide 1-150 weight ppm of platinum on the same basis. The hydrosilylation catalyst may be added as a single species or as a mixture of two or more different species.

### Component (D)

The trisiloxane and/or components thereof are typically formed and/or provided in (D) a carrier fluid. Suitable carrier fluids (or carriers, diluents, solvents, or vehicles) include silicones, both linear and cyclic, organic oils, organic solvents and mixtures of these. Specific examples of solvents may be found in U.S. Pat. No. 6,200,581, which is incorporated herein by reference for this purpose. In various embodiments, the carrier fluid comprises a volatile siloxane, an organic solvent, or combination thereof.

In certain embodiments, the carrier fluid is a low viscosity silicone, a volatile methyl siloxane, a volatile ethyl siloxane, or a volatile methyl ethyl siloxane, having a viscosity at 25° C. in the range of 1-1,000 mm²/sec. Suitable silicones/siloxanes include hexamethyldisiloxane, hexamethylcyclotrisiloxane, octamethylcyclotetrasiloxane (D4), decamethylcyclopentasiloxane (D5), dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilypoxy)}trisiloxane, hexamethyl-3,3,bis{(trimethylsilyl)oxy}trisiloxane, and pentamethyl{(trimethylsilyl)oxy}cyclotrisiloxane, as well as polydimethylsiloxanes, polyethylsiloxanes, polymethylethylsiloxanes, polymethylphenylsiloxanes, and polydiphenylsiloxanes.

Suitable organic solvents include aromatic hydrocarbons (e.g. toluene, xylene, etc.), aliphatic or alicyclic hydrocarbons (e.g. n-pentane, n-hexane, cyclohexane, etc.), alcohols (e.g. methanol, isopropanol, etc.), aldehydes, ketones, esters, ethers, glycols, glycol ethers, alkyl halides and aromatic halides. Suitable hydrocarbons include isododecane, isohexadecane, Isopar L (C₁₁-C₁₃), Isopar H (C₁₁-C₁₂), and hydrogenated polydecene. Suitable halogenated hydrocarbons include dichloromethane, chloroform, and carbon tetrachloride. Suitable ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic carrier fluids suitable as a stand-alone compound or as an ingredient to the carrier fluid include fats, oils, fatty acids, and fatty alcohols. Additional examples of suitable carriers/solvents are described as “carrier fluids” in US Pat. App. Pub. No. 2010/0330011, which is incorporated herein by reference for this purpose.

To prevent undesirable side-reactions/reaction-products, the carrier fluid should be inert with respect to the reactants/reaction-intermediates utilized to form the trisiloxane. For example, the carrier fluid shouldn't have epoxy, Si—H, ethylenically unsaturated, and/or amine functional groups. The amount of carrier fluid used is not particularly limited. Combinations of carrier fluids can be utilized.

### Composition

A composition comprising the trisiloxane is also provided. As introduced above, the trisiloxane is useful for a number of applications and such applications are not particularly limited. Suitable applications include use in automatic dishwashing (ADW) formulations, household cleaners, auto care detergents, liquid and powdered laundry detergents, and stain removal products. Further suitable applications utilizing the trisiloxane include pigment treatments and texture modification to aqueous based formulations. Other applications of the trisiloxane include use as an additive for urethane leather finishes and as a reactive internal lubricant for polyester fiber melt spinning. The trisiloxane may also be utilized as (or in place of) surfactants and processing aids for dispersion of particles in silicone or other formulations.

In certain embodiments, the trisiloxane is used as a detergent additive. In many embodiments, the trisiloxane meets requirements according to Regulation (EC) No. 648/2004 of the European Parliament and of the Council on detergents, which is incorporated herein by reference along with any subsequent amendments/annexes thereof including EC Nos. 907/2006 and 551/2009. The trisiloxane is generally not a “surfactant” as defined according to EC No. 648/2004. In various embodiments, the composition is a cleaning composition, a coating composition, an agricultural composition, or an ink composition.

In certain embodiments, the composition is a cleaning composition. In further embodiments, the composition is a detergent composition (which may simply be referred to as a detergent). The detergent composition can be, for example, a dishwashing detergent composition (e.g. an auto dishwashing detergent composition), a laundry detergent composition, or a hard surface detergent composition. The trisiloxane is especially useful in such cleaning compositions. Further applications where the trisiloxane can be utilized include: cosmetics, personal care and personal cleansing products (e.g. body washes, shampoos, and conditioners); dishwashing products including hand dishwashing, automatic dishwashing, and dishwashing additives; laundry care including laundry detergents (e.g. hand wash/automatic detergents), fabric softeners, carpet cleaners, and laundry aids (e.g. spot and stain removers); surface care including multi-purpose cleaners, cleaners for ovens, window/glass, metal, kitchen, floor, bathroom surfaces, descalers, drain openers, scouring agents, household antiseptics/disinfectants, and household care wipes and floor cleaning systems; and toilet care products including in-cistern devices, rim blocks and liquids, and liquids, foams, gels and tablets for toilet care.

In various embodiments, the cleaning composition can be an aqueous solution, a gel, or a powder. The cleaning composition can be dispensed as such directly onto laundry fabrics or via a spray, a roll-on, and/or an adhesive patch (also directly onto the laundry fabrics) before a washing process. Such cleaning compositions can also be delivered within the washing and/or rinse phase of an automatic or manual laundry washing process.

The trisiloxane can be utilized in the composition in various amounts. Suitable amounts for a particular end-use/application can be readily determined via routine experimentation. Combinations of trisiloxanes can be utilized.

In certain embodiments where the composition is a detergent composition, the trisiloxane is present in an amount of from about 0.001 to about 20, alternatively about 0.001 to about 15, alternatively about 0.001 to about 10, alternatively about 0.01 to about 5, and alternatively about 0.01 to about 1, part(s) by weight, based on 100 parts by weight of the detergent composition. Such ranges are generally associated with a “final” or “consumer” detergent composition. As such, the amounts above can be increased or decreased by orders of magnitude to account for change in concentration and/or form. For example, in embodiments where the detergent composition is in the form of a concentrate, gel, or powder, the amounts above may be increased by about 10%, 25%, 50%, 100%, 200%, 300%, 400%, 500%, or more. If the detergent composition is diluted, the amounts above may be decreased in a similar manner. These amounts may also be utilized in other types of compositions.

In various embodiments, the composition further comprises at least one dispersant. Various types of conventional dispersants associated with cleaning compositions can be utilized. In specific embodiments, the dispersant comprises propylene glycol. The dispersant is useful for increasing compatibility of certain embodiments of the trisiloxane and/or amounts thereof in the composition.

In certain embodiments where the composition is a detergent composition, the dispersant is present in an amount of from about 0.01 to about 50, alternatively about 0.1 to about 40, alternatively about 0.1 to about 30, alternatively about 0.1 to about 25, alternatively about 1 to about 20, alternatively about 2 to about 15, alternatively about 2 to about 10, and alternatively about 2 to about 5, part(s) by weight, based on 100 parts by weight of the detergent composition. Such ranges are generally associated with a “final” or “consumer” detergent composition. As such, the amounts above can be increased or decreased to account for change in concentration and/or form. For example, in embodiments where the detergent composition is in the form of a concentrate, gel, or powder, the amounts above may be increased by about 10%, 25%, 50%, 100%, 200%, 300%, 400%, 500%, or more. If the detergent composition is diluted, the amounts above may be decreased in a similar manner. These amounts may also be utilized in other types of compositions.

The composition, e.g. detergent composition, may further comprise any number of conventional compounds or additives understood in the art and such components can be utilized in various amounts. For example, the composition can be an aqueous detergent composition including various amounts of water. In addition, the cleaning composition can include at least one surfactant, including anionic surfactants, cationic surfactants, zwitterionic (amphoteric) surfactants, nonionic surfactants, or combinations thereof. Further components suitable for the cleaning/detergent composition include abrasives, acids, alkalis/bases, antimicrobial agents, antiredeposition agents, antiscalants, bleaches, builders, chelating agents, colorants, complexing agents, corrosion inhibitors, electrolytes, enzymes, extenders, extracts, fabric softening agents, fillers, fluorescent whitening agents, fragrances/perfumes, foam inhibitors, formulation auxiliaries, hydrotropes, opacifiers, preservatives, processing aids, salts, soaps, soil release polymers, solvents, solubility improvers, suds control agents, oils, oxidizing agents, or combinations thereof. Other detergent compositions and components thereof can be better appreciated with reference to U.S. application No. 62/328,072 (Atty. Docket No. DC16004), which is incorporated herein by reference for this purpose.

The following Examples, illustrating various trisiloxanes and related methods of formation, are intended to illustrate and not limit the present invention.

### Example 1: Hydrosilylation of Heptamethyltrisiloxane and 2-Allyloxyethanol

13.29 g of heptamethyltrisiloxane (98%, TCI America) and 20 g of toluene (>99.5%, Fisher Scientific) were added to a reaction flask under a nitrogen purge and mixed with a magnetic stirrer. The mixture was kept under the nitrogen purge and heated to 40° C. A syringe was loaded with 7.87 g of 2-allyloxyethanol (98%, Aldrich) and placed into a syringe pump. Once at 40° C., the 2-allyloxyethanol was metered into the reaction at ˜250 μL/min. After ˜5% of 2-allyloxyethanol was added, 108.8 μL of a 1% platinum complex in hexamethyldisiloxane was added. The reaction exothermed initially and as the remaining 2-allyloxyethanol was added reaching a maximum temperature of 59.5° C. 6.82 g total of 2-allyloxyethanol was added. The reaction was held at 60° C. for 3 hours and then allowed to cool.

The resulting sample was treated with activated carbon and filtered. Unreacted heptamethyltrisiloxane (BisH) and toluene were stripped off using a rotary evaporator (Rotovap) for 3 hours (75° C., <10 mbar). The sample was then held at room temperature at 0.15 torr for 24 hours. 1H, 29Si and 13C confirmed the target hydrosilylated reaction product, with only trace isomers remaining. Specifically, the chemical composition after stripping was as follows: BisH-2-allyloxyethanol—99.46 wt %; and 2-allyloxyethanol isomers—0.54 wt %. The trisiloxane formed in this example has one hydroxyl functional (—OH) group. A reaction scheme of this example is illustrated immediately below.

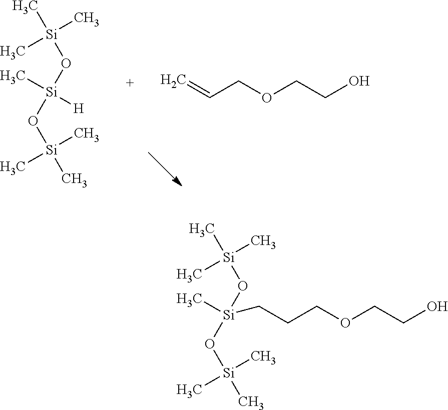

### Example 2: Hydrosilylation of Heptamethvltrisiloxane and Trimethylolpropane Allyl Ether

10.75 g of heptamethyltrisiloxane (98%, TCI America) and 20 g of toluene (≥99.5%, Fisher Scientific) were added to a reaction flask under a nitrogen purge and mixed with a magnetic stirrer. The mixture was kept under the nitrogen purge and heated to 40° C. A syringe was loaded with 11.37 g of trimethylolpropane allyl ether (98%, Aldrich) and placed into a syringe pump. Once at 40° C., the trimethylolpropane allyl ether was metered into the reaction at ˜250 μL/min. After ˜5% of trimethylolpropane allyl ether was added, 87.9 μL of a 1% platinum complex in hexamethyldisiloxane was added. The reaction exothermed initially and as the remaining trimethylolpropane allyl ether was added reaching a maximum temperature of 58.9° C. 9.44 g total of trimethylolpropane allyl ether was added. The reaction was held at 60° C. for 3 hours and then allowed to cool.

The resulting sample was treated with activated carbon and filtered. Unreacted BisH and toluene were stripped off using a rotary evaporator for 1 hour (60° C., <10 mbar). The sample was then held at room temperature at 0.2 torr for 24 hours. 1H, 29Si and 13C confirmed the target hydrosilylated reaction product, as well as ˜4.37 wt % isomers and less than 0.1 wt % solvent remaining. Specifically, the chemical composition after stripping was as follows: BisH-Trimethylolpropane allyl ether—95.58 wt %; trimethylolpropane allyl ether isomers—4.37 wt %; and toluene—0.05 wt %. The trisiloxane formed in this example has two hydroxyl functional groups. A reaction scheme of this example is illustrated immediately below.

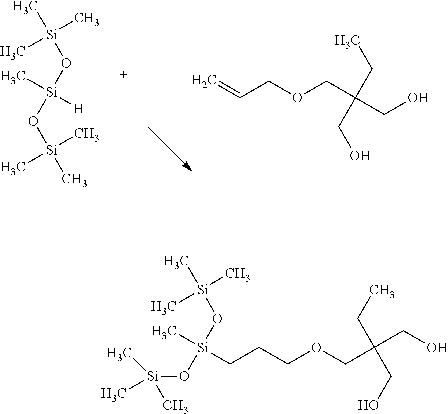

### Example 3: Preparation of Trisiloxane Monoqlycerol

125.58 g of 1,1,1,3,5,5,5-Heptamethyltrisiloxane (BisH), 22.5 g of allyl glycerol and 168 g of isopropyl alcohol (IPA) were added to a reaction flask under a nitrogen purge and mixed by an agitator. The mixture was kept under the nitrogen purge and heated to 70° C. 0.3 g of a 1.1% platinum complex in hexamethyldisiloxane/IPA was added. The reaction exothermed initially. 25.2 g of allyl glycerol, 16.8 g of IPA and 0.3 g of 1.1% platinum complex in hexamethyldisiloxane/IPA were added as a 2nd step. 25.2 g of allyl glycerol, 12.6 g of IPA and 0.3 g of 1.1% platinum complex in hexamethyldisiloxane/IPA were added as a 3rd step. 16.8 g of allyl glycerol, 12.6 g of IPA and 0.209 g of 1.1% platinum complex in hexamethyldisiloxane/IPA were added as a 4th step. 89.7 g total of allyl glycerol was added for 125.58 g total of BisH. The reaction was held at 70° C. for 6 hours and then allowed to cool.

The sample was treated with activated carbon and filtered. Unreacted BisH and IPA were stripped off using a vacuum pump for 2 hours (80° C., <10 mmHg). 1H, 29Si and 13C confirmed the target hydrosilylated reaction product, with only trace isomers remaining. Specifically, the chemical composition after stripping was as follows: BisH-allyl glycerol—96.50 wt %; and allyl glycerol isomers—3.50 wt %. The trisiloxane formed in this example has two hydroxyl functional groups as illustrated immediately below.

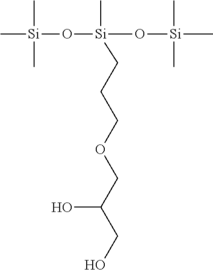

### Example 4: Hydrosilylation of BisH and Allyl Glycerol

12.096 g of BisH and 20.00 g of IPA were mixed in a reaction flask under a nitrogen purge and heated to 40° C. A syringe was loaded with 7.904 g of allyl glycerol and then loaded into a syringe pump. Once at 40° C., the allyl glycerol was metered into the reaction at 669 μL/min. A 1% solution of Karstedt's catalyst in hexamethyldisiloxane (98.98 μL) was added after ˜5% of the allyl glycerol had been added to yield 18 ppm Pt catalyst. The reaction was allowed to exotherm and cool down to 60° C. after all of the allyl glycerol was added. The reaction was then held at 60° C. for 3 hours and then allowed to cool.

Unreacted BisH and IPA were stripped off using a Rotovap for 3 hours (75° C., 3 mbar). The chemical composition after stripping was as follows: BisH-3-allyloxy-1,2-propane diol—95.36 wt %; and isomers—4.64 wt %. The trisiloxane formed in this example has two hydroxyl functional groups. A reaction scheme of this example is illustrated immediately below.

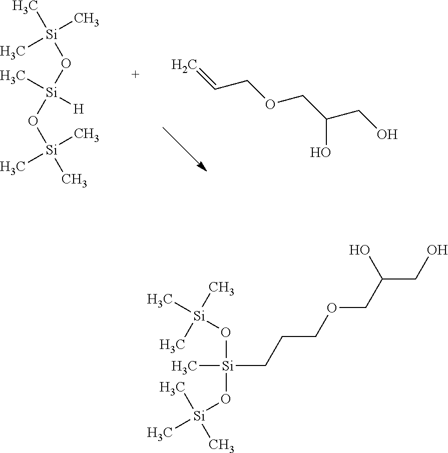

### Example 5: Hydrosilylation of Heptamethyltrisiloxane and Allyl Glycidyl Ether

71.22 g of BisH and 43.78 g of allyl glycidyl ether (AGE) were mixed in a reaction flask under a nitrogen purge and heated to 60° C. Once at 60° C., a 1% solution of Karstedt's catalyst in IPA was added to the solution (24.42 μL) to yield 8 ppm Pt. The reaction was allowed to exotherm and cool down to 75° C. The reaction was held at 75° C. for 3 hours and then allowed to cool.

Unreacted BisH, excess AGE, and AGE isomers were stripped off using simple vacuum distillation for 3 hours (90° C., 5 mmHg). The chemical composition after stripping was as follows: BisH-AGE—100.00 wt %. A reaction scheme of this example is illustrated immediately below.

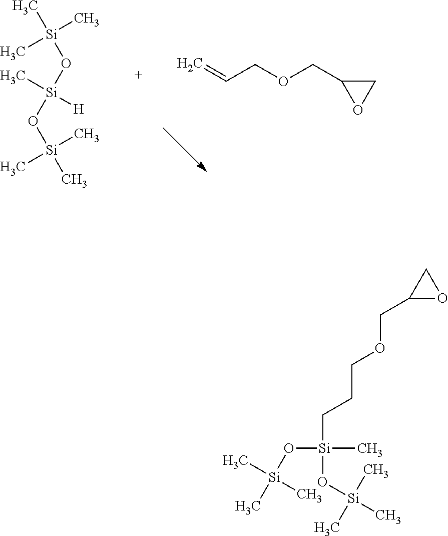

### Example 6: Epoxy Ring-Opening Reaction of BisH-AGE and Diethanolamine

83.430 g of the epoxy functional trisiloxane intermediate produced in Example 5, 26.056 g of diethanolamine (DEA), and 30.000 g of IPA were added to a reaction flask. The reaction was performed in an inert atmosphere using a nitrogen purge across the reaction solution. The reaction was then heated to 75° C. and held at these conditions until completion.

The IPA was removed using simple vacuum distillation for 3 hours (45° C., ˜5 mmHg). The reaction progress was tracked via H1 NMR. The reaction was considered complete once the CH peak on the epoxy shifted completely from ˜3.1 ppm to ˜3.9 ppm. The chemical composition after vacuum distillation was as follows: BisH-AGE-DEA—99.70 wt %; and IPA—0.30 wt %. The trisiloxane formed in this example has three hydroxyl functional groups. A reaction scheme of this example is illustrated immediately below.

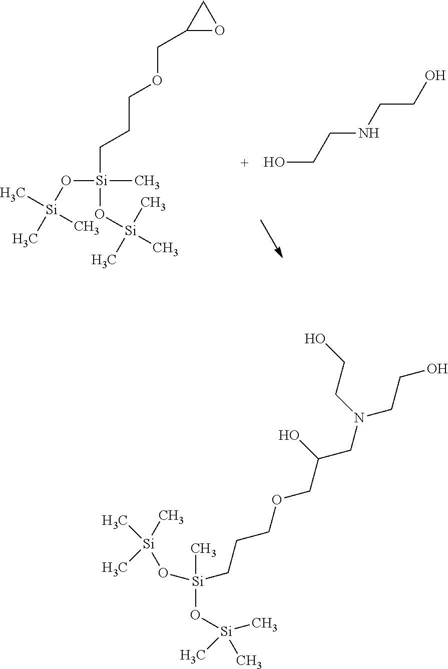 [SMILES: C[Si](C)(C)O[Si](C)(CCCOCC1CO1)O[Si](C)(C)C ; OCCNCCO ; C[Si](C)(C)O[Si](C)(CCCOCC(O)CN(CCO)CCO)O[Si](C)(C)C]

### Example 7: Epoxy Ring-Opening Reaction of BisH-AGE and Diisopropanolamine

65.849 g of the epoxy functional trisiloxane intermediate produced in Example 5, 26.052 g of diisopropanolamine (DIPA), and 30.000 g of IPA were added to a reaction flask. The reaction was performed in an inert atmosphere using a nitrogen purge across the reaction solution. The reaction was then heated to 75° C. and held at these conditions until completion.

The IPA was removed using simple vacuum distillation for 3 hours (45° C., ˜5 mmHg). The reaction progress was tracked via H1 NMR. The reaction was considered complete once the CH peak on the epoxy shifted completely from ˜3.1 ppm to ˜3.9 ppm. The chemical composition after vacuum distillation was as follows: BisH-AGE-DIPA—99.70 wt %; and IPA—0.30 wt %. The trisiloxane formed in this example has three hydroxyl functional groups. A reaction scheme of this example is illustrated immediately below.

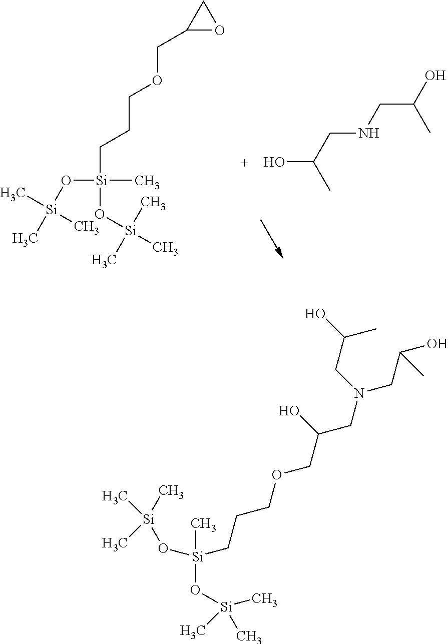

### Example 8: Hydrosilylation of BisH and Allyl Diglycerol

56.81 g of BisH and half of the total allyl diglycerol (71.19 g total) were mixed in a reaction flask under a nitrogen purge and heated to 45° C. Once at 45° C., a 1% solution of Karstedt's catalyst in IPA (25.48 μL) was added to yield 8 ppm Pt. The reaction was allowed to exotherm and cool down to 80° C. The second half of the allyl diglycerol was added to the reaction solution. The reaction was once again allowed to exotherm and cool to 70° C. The reaction was then held at 70° C. for 4 hours and then allowed to cool.

The chemical composition after reaction was as follows: BisH-allyl diglycerol—88.88 wt %; and isomers—11.12 wt %. The trisiloxane formed in this example has three hydroxyl functional groups as illustrated immediately below.

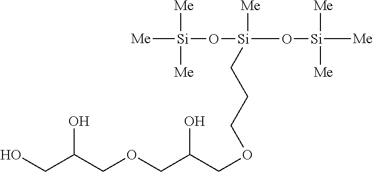 [SMILES: C[Si](C)(C)O[Si](C)(CCCOCC(O)COCC(O)CO)O[Si](C)(C)C]

### Example 9: Hydrosilylation of BisH and Allyl Xylitol

9.739 g of allyl xylitol and 20.017 g of IPA were mixed in a reaction flask under a nitrogen purge and heated to 50° C. A syringe was loaded with 10.261 g of BisH and then loaded into a syringe pump. Once at 50° C., the BisH was metered into the reaction at 881 μL/min. A 1% solution of Karstedt's catalyst in hexamethyldisiloxane (83.96 μL) was added after ˜5% of the BisH had been added to yield 16 ppm Pt. The reaction was allowed to exotherm and cool down to 60° C. after all of the BisH was added. The reaction was then held at 60° C. for 3 hours and then allowed to cool.

Unreacted BisH and IPA were stripped off using a Rotovap for 3-5 hours (75° C., 3 mbar). The chemical composition after stripping was as follows: BisH-allyl xylitol—97.74 wt %; and isomers—2.86 wt %. The trisiloxane formed in this example has four hydroxyl functional groups. A reaction scheme of this example is illustrated immediately below.

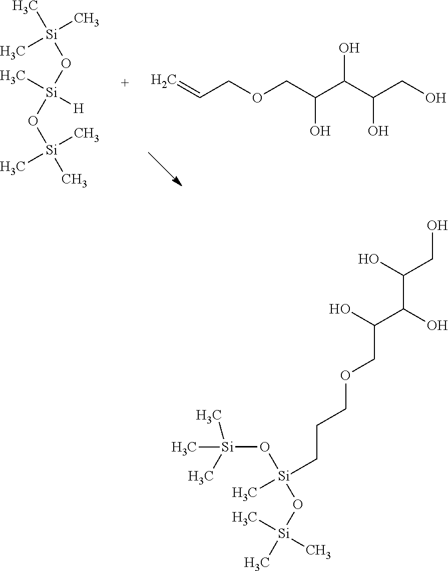

### Example 10: Epoxy Ring-Opening Reaction of BisH-AGE-Tris(Hydroxymethyl) Aminomethane

5.516 g of the epoxy functional trisiloxane intermediate produced in Example 5, 1.984 g of tris(hydroxymethyl) aminomethane (Tris), 5.250 g of methanol and 12.250 g of IPA were added to a reaction flask. The reaction was performed in an inert atmosphere using a nitrogen purge across the reaction solution. The reaction was then heated to 75° C. and held at these conditions until the reaction was complete.

The IPA and methanol were stripped off using a Rotovap (75° C., 3 mbar). The reaction progress was tracked via H1 NMR. The reaction was considered complete once the CH peak on the epoxy shifted completely from ˜3.1 ppm to ˜3.9 ppm. The chemical composition after stripping was as follows: BisH-AGE-Tris—99.70 wt %; and IPA—0.30 wt %. The trisiloxane formed in this example has four hydroxyl functional groups. A reaction scheme of this example is illustrated immediately below.

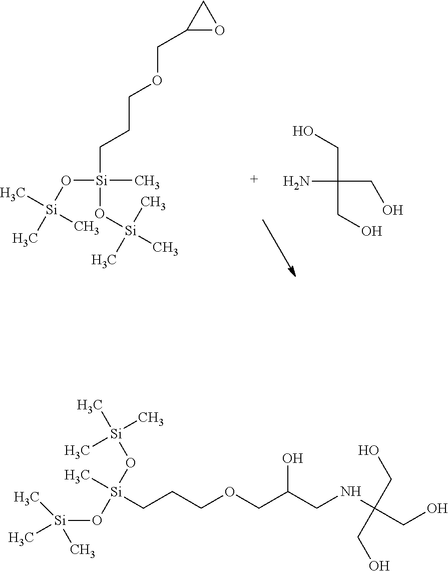 [SMILES: C[Si](C)(C)O[Si](C)(CCCOCC1CO1)O[Si](C)(C)C ; NC(CO)(CO)CO ; C[Si](C)(C)O[Si](C)(CCCOCC(O)CNC(CO)(CO)CO)O[Si](C)(C)C]

### Example 11: Epoxy Ring-Opening Reaction of BisH-AGE and n-Methylglucamine

15.824 g of the epoxy functional trisiloxane intermediate produced in Example 5, 9.176 g of n-methylglucamine (NMG), 8.750 g of methanol and 16.250 g of IPA were added to a reaction flask. The reaction was performed in an inert atmosphere using a nitrogen purge across the reaction solution. The reaction was then heated to 75° C. and held at these conditions for until the reaction was complete.

The methanol and IPA were stripped off using a Rotovap for 3 hours (75° C., 3 mbar). The reaction progress was tracked via H1 NMR. The reaction was considered complete once the CH peak on the epoxy shifted completely from ˜3.1 ppm to ˜3.9 ppm. The chemical composition after stripping was as follows: BisH-AGE-NMG—98.20 wt %; and IPA—1.80 wt %. The trisiloxane formed in this example has six hydroxyl functional groups. A reaction scheme of this example is illustrated immediately below.

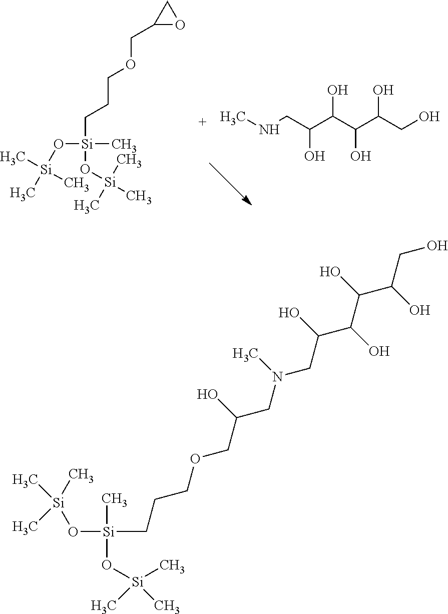 [SMILES: C[Si](C)(C)O[Si](C)(CCCOCC1CO1)O[Si](C)(C)C ; CNCC(O)C(O)C(O)C(O)CO ; CN(CC(O)COCCC[Si](C)(O[Si](C)(C)C)O[Si](C)(C)C)CC(O)C(O)C(O)C(O)CO]

### Example 12: Epoxy Ring-Opening Reaction of AGE and DIPA

12.855 g of AGE, 12.500 g of DIPA, and 24.645 g of toluene were added to a reaction flask. The reaction was performed in an inert atmosphere using a nitrogen purge across the reaction solution. The reaction was then heated to 75° C. and held at these conditions until completion.

The toluene was stripped off using a Rotovap for 3 hours (75° C., 3 mbar). The reaction progress was tracked via H1 NMR. The reaction was considered complete once the CH peak on the epoxy shifted completely from ˜3.1 ppm to ˜3.9 ppm. The chemical composition after stripping was as follows: AGE-DIPA—99.70 wt %; and toluene—0.30 wt %. A reaction scheme of this example is illustrated immediately below (where each R is a propanol group).

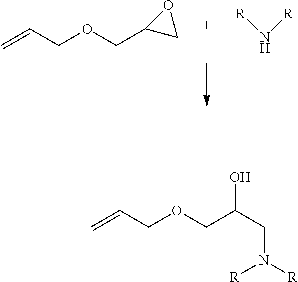

### Example 13: Hydrosilylation of BisH and Allyl AGE-DIPA

1.2594 g of BisH, 1.266 g of the allyl AGE-DIPA material produced in Example 12, and 2.052 g of IPA were mixed in a reaction flask under a nitrogen purge and heated to 60° C. Once at 60° C., a 1% solution of Karstedt's catalyst in hexamethyldisiloxane (20.26 μL) was added to the solution to yield 30 ppm Pt. The reaction was allowed to exotherm and cool down to 70° C. The reaction was then held at 70° C. until completion.

The reaction was considered complete when there was no longer an unreacted Si—H peak at ˜4.56 ppm in the H1 NMR spectra. The IPA was stripped off using a Rotovap for 4 hours (75° C., 3 mbar). The chemical composition after stripping was as follows: BisH-AGE-DIPA—89.77 wt %; AGE-DIPA isomers—9.99 wt %; and IPA—0.24 wt %. The trisiloxane formed in this example has three hydroxyl functional groups. A reaction scheme of this example is illustrated immediately below.

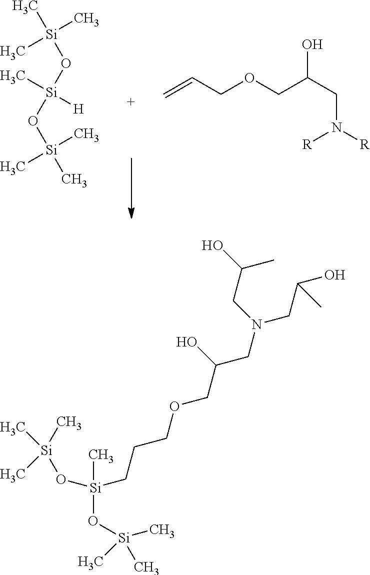

### Example 14 (Prophetic): Hydrosilylation of BisH and Allyl Sorbitol

10.3 g of allyl sorbitol and 20.017 g of IPA are mixed in a reaction flask under a nitrogen purge and heated to 50° C. A syringe is loaded with 10.3 g of BisH and then loaded into a syringe pump. Once at 50° C., the BisH is metered into the reaction at 881 μL/min. A 1% solution of Karstedt's catalyst in hexamethyldisiloxane (83.96 μL) is added after ˜5% of the BisH has been added to yield 16 ppm Pt. The reaction is allowed to exotherm and cool down to 60° C. after all of the BisH is added. The reaction is then held at 60° C. for 3 hours and then allowed to cool.

Unreacted BisH and IPA are stripped off using a Rotovap for 5 hours (75° C., 3 mbar). The chemical composition after stripping is estimated as follows: BisH-allyl sorbitol—96.0 wt %; and isomers—4.0 wt %. The trisiloxane formed in this example has five hydroxyl functional groups. A reaction scheme of this example is illustrated immediately below.

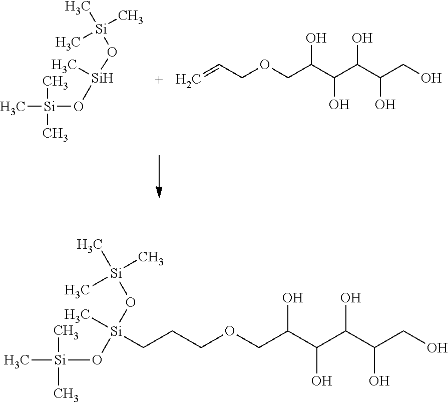

The terms “comprising” or “comprise” are used herein in their broadest sense to mean and encompass the notions of “including,” “include,” “consist(ing) essentially of,” and “consist(ing) of”. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1. A trisiloxane having at least one carbinol functional group, said trisiloxane comprising the reaction product of:
(A) an initial trisiloxane having a pendant silicon-bonded functional group selected from a hydrogen atom, an epoxy-containing group, an ethylenically unsaturated group, and an amine group; and
(B) an organic compound having a functional group reactive with the pendant silicon-bonded functional group of component (A) and at least one hydroxyl functional group;
subject to the following provisos;
if the pendant silicon-bonded functional group of component (A) is a hydrogen atom, the functional group of component (B) is an ethylenically unsaturated group of formula (B1): 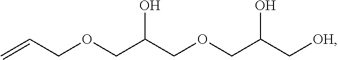
if the pendant silicon-bonded functional group of component (A) is an epoxy-containing group, the functional group of component (B) is an amine group,
if the pendant silicon-bonded functional group of component (A) is an ethylenically unsaturated group, the functional group of component (B) is a hydrogen atom, and
if the pendant silicon-bonded functional group of component (A) is an amine group, the functional group of component (B) is an epoxy-containing group;
wherein component (A) is free of a terminal silicon-bonded functional group selected from a hydrogen atom, an epoxy-containing group, an ethylenically unsaturated group, and an amine group; and
wherein component (A) is free of polyoxyalkylene groups.

2. The trisiloxane as set forth in claim 1, wherein component (A) is of the following general formula (A1):
(R¹₃SiO_{1/2})(R¹R²SiO_{2/2})(R¹₃SiO_{1/2}) (A1);
wherein each R¹ is an independently selected hydrocarbyl group, alternatively each R¹ is an independently selected C₁-C₆ alkyl group, and R² is the pendant silicon-bonded functional group defined above.

3. The trisiloxane as set forth in claim 1, having one to six carbinol functional groups, alternatively three to four carbinol functional groups.

4. The trisiloxane as set forth in claim 1, wherein the pendant silicon-bonded functional group of component (A) is a hydrogen atom.

5. (canceled)

6. The trisiloxane as set forth in claim 1, wherein the pendant silicon-bonded functional group of component (A) is an epoxy-containing group.

7. The trisiloxane as set forth in claim 1, wherein the pendant silicon-bonded functional group of component (A) is an epoxy-containing group and component (B) is selected from the following components (B2) to (B4):

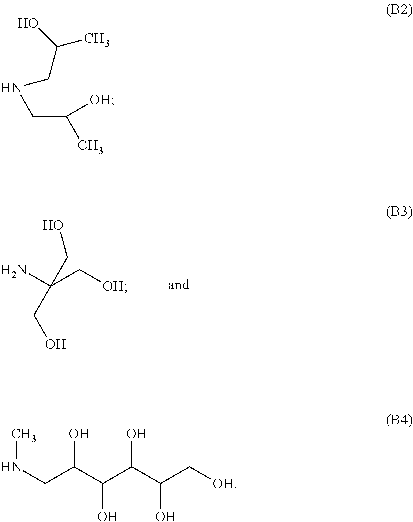

8. A trisiloxane of the following general formula (I):
(R¹₃SiO_{1/2})(R¹R³SiO_{2/2})(R¹₃SiO_{1/2}) (I);
wherein each R¹ is an independently selected hydrocarbyl group and R³ is selected from the following groups (i) to (iv);

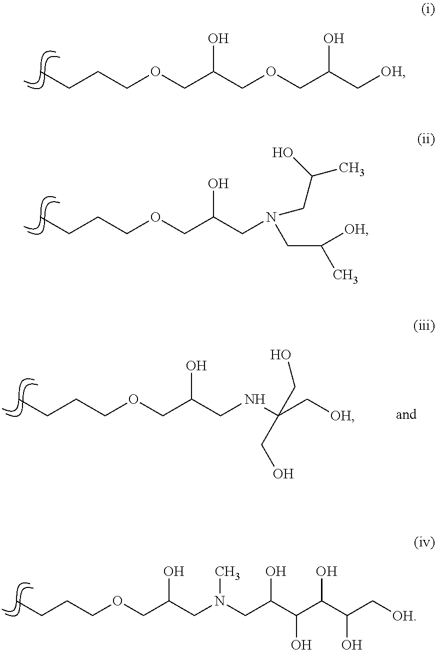 [SMILES: CCCCOCC(O)COCC(O)CO ; CCCCOCC(O)CN(CC(C)O)CC(C)O ; CCCCOCC(O)CNC(CO)(CO)CO ; CCCCOCC(O)CN(C)CC(O)C(O)C(O)C(O)CO]

9. The trisiloxane as set forth in claim 8, wherein each R¹ is an independently selected C₁-C₆ alkyl group, alternatively each R¹ is a methyl group.

10. A composition comprising the trisiloxane as set forth in claim 1.

11. The composition as set forth in claim 10, further comprising at least one dispersant, alternatively further comprising propylene glycol.

12. The composition as set forth in claim 10, further defined as a cleaning composition, a coating composition, an agricultural composition, or an ink composition, alternatively a cleaning composition.

13. A method of forming the trisiloxane as set forth in claim 1, said method comprising the steps of:
(1) providing component (A);
(2) providing component (B); and
(3) reacting components (A) and (B) to form the trisiloxane.

14. The method as set forth in claim 13,
wherein step (1) is further defined as;
(1a) reacting a hydrogentrisiloxane with an epoxy compound having an ethylenically unsaturated group in the presence of (C) a hydrosilylation catalyst to form a reaction intermediate having the epoxy-containing group; and
wherein component (B) is an amine compound and step (3) is further defined as;
(3a) reacting component (B) and the reaction intermediate formed in step (1a) to form the trisiloxane;
optionally, further comprising the step(s) of;
(1b) removing unreacted epoxy compound after step (1a), and/or
(3b) removing unreacted component (B) after step (3a).

15. The method as set forth in claim 13,
wherein step (2) is further defined as;
(2a) reacting an amine compound having at least one hydroxyl functional group with an epoxy compound having an ethylenically unsaturated group to form a reaction intermediate having the ethylenically unsaturated group; and
wherein component (A) is a hydrogentrisiloxane and step (3) is further defined as;
(3a) reacting component (A) and the reaction intermediate formed in step 2a) in the presence of (C) a hydrosilylation catalyst to form the trisiloxane;
optionally, further comprising the step(s) of;
(2b) removing unreacted compounds after step (2a), and/or
(3b) removing unreacted component (A) after step (3a).
